(19) United States
(12) Patent Application Publication
(10) Pub. No.: US 2015/0332149 A1
(43) Pub. Date: Nov. 19, 2015

(54) TRACKING BEHAVIOR AND GOAL ACHIEVEMENT

(71) Applicant: Red Lozenge, Inc., San Mateo, CA (US)

(72) Inventors: Samuel Kolb, San Mateo, CA (US); Alexandros Kostibas, San Francisco, CA (US); Timothy Sutcliffe, San Francisco, CA (US); Mark Wallace, San Francisco, CA (US)

(21) Appl. No.: 14/685,371

(22) Filed: Apr. 13, 2015

Related U.S. Application Data
(60) Provisional application No. 61/993,757, filed on May 15, 2014.

(51) Int. Cl. G06N 5/04; G06N 99/00

(52) U.S. Cl. CPC G06N 5/04; G06N 99/005

(57) ABSTRACT

Methods, systems, and apparatus, including computer programs encoded on a computer storage medium, for receiving user selection of a goal and a time period, wherein the goal specifies a desired behavior of a user to occur within the time period, determining a schedule for the selected goal based on the time period wherein the schedule indicates one or more times when the goal should be met, selecting a behavior based on, at least, the selected goal wherein the behavior is a physical behavior that can be expressed by an avatar, obtaining data indicating the user's progress towards reaching the goal, determining a degree of the behavior based on the user's progress and a time when the goal should be next be met, and providing an animation of an avatar wherein the avatar expresses the behavior in the animation according to the determined degree of the behavior.

### RELATED APPLICATION

This application claims the benefit of U.S. provisional patent application No. 61/993,757, titled TRACKING BEHAVIOR AND GOAL ACHIEVEMENT, filed May 15, 2014, which is incorporated herein by reference.

### BACKGROUND

This specification relates to software applications on client devices and, more particularly, goal tracking software applications.

### SUMMARY

In general, one aspect of the subject matter described in this specification can be embodied in methods that include the actions of receiving user selection of a goal or of a plurality of different goals and a time period, wherein the goal specifies a desired behavior of a user to occur within the time period; determining a schedule for the selected goal based on the time period wherein the schedule indicates one or more times when the goal should be met; selecting a behavior based on, at least, the selected goal wherein the behavior is a physical behavior that can be expressed by an avatar in an animation of the avatar; obtaining data indicating the user's progress towards reaching the goal; determining a degree of the behavior based on the user's progress and a time when the goal should be next be met; and providing an animation of an avatar wherein the avatar expresses the behavior in the animation according to the determined degree of the behavior. Other embodiments of this aspect include corresponding systems, apparatus, and computer programs.

These and other aspects can optionally include one or more of the following features. A particular goal can be an amount of food or beverage to consume in the time period, an amount of physical exercise to complete in the time period, or an amount of sleep or rest to complete in the time period. A particular physical exercise can be walking, running, jumping jacks, push-ups, pull-ups, weight training, boxing, kick boxing, bike riding, basketball, or swimming. Determining the degree of behavior comprises calculating a time remaining before the time when the goal should next be met, and calculating the degree of the behavior based on the time remaining A particular behavior can be an expression of boredom, happiness, fatigue, impatience, strength, or dismay. Obtaining the data can comprise obtaining the data from user input or one or more devices that are configured to record physiological properties of a user. A particular device can be a personal health monitor, a personal activity tracker, a smart watch, smart glasses, or a smart phone. A particular physiological property can be distance walked, distance ran, type of activity, activity duration, resting heart rate, exercise heart rate, resting blood pressure, exercise blood pressure, glucose level, amount of liquid consumed, amount of sleep, gender, height, weight, and age. The expressed behavior can affect one or more physical attributes of the avatar. A particular physical attribute can be one of: posture, weight, muscle strength of a muscle group, muscle mass, facial expression, or clothing worn by the avatar. The aspect can further comprise determining a model of the avatar based on the physical attributes of the avatar, and providing the model for use in an electronic game. The aspect can further comprise generating a training schedule for the user based on one or more physical attributes of another avatar of another user. Providing the animation of the avatar can comprise presenting the animation of the avatar on a client device associated with the user. The aspect can further comprise notifying the user to achieve the goal before the time when the goal should next be met. Notifying the user to achieve the goal can comprises learning times that are appropriate to notify the user based on the user's daily activities, and notifying the user during one of the learned times. The aspect can further comprise providing a respective animation for one or more second avatars that each express a respective behavior in the animation according to a respective determined degree of the behavior for a different respective user. The aspect can further comprise updating the animations over time to reflect changes in respective determined behavior over time. Each respective animation can be of a physical activity. The physical activity can be one of: walking, running, jumping jacks, push-ups, pull-ups, weight training, boxing, kick boxing, bike riding, basketball, and swimming.

Particular implementations of the subject matter described in this specification can be implemented to realize one or more of the following advantages. The system described herein selects a behavior that can be expressed by an avatar in an animation, obtains data indicating a user's progress toward a goal selected by the user, determines a degree of the behavior based on the user's progress toward the selected goal, and presents to the user an animation of the avatar expressing the determined degree of the behavior. The system can also present to the user avatars expressing respective determined degree of the behavior of other users. The system can help a user to achieve a fitness goal by providing to the user a visual representation of the user's progress, and interaction with other users on respective progress on the fitness goal.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for tracking behavior and goal achievement.

FIG. 2 is a flow chart of an example method for achieving personal goals.

FIG. 3 is an example user interface illustrating an avatar expressing an action or behavior.

FIG. 4 is an example user interface illustrating avatars representing different users.

FIG. 5 illustrates an example mobile computing device.

### DETAILED DESCRIPTION

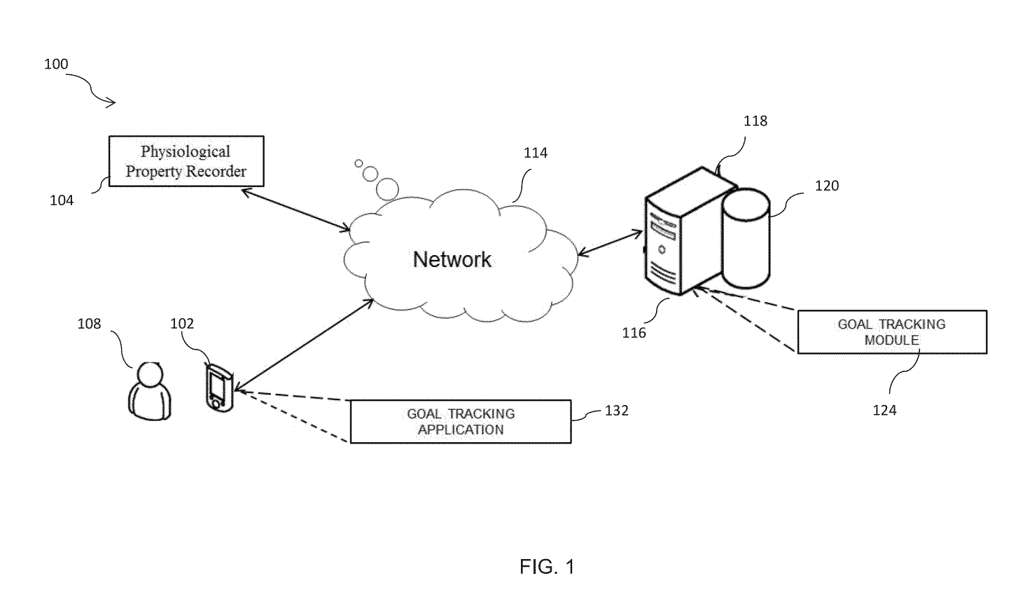

In certain implementations this disclosure relates to computer implemented systems and methods that can be used to help users achieve their goals. In some instances the methods can be executed by an application located on a client device or one or more servers accessible from the client device. FIG. 1 is a block diagram of a system on which the application can be implemented. System 100 includes a client device 102 that can be configured to communicate with a physiological property recorder 104 and/or a server system 116 over a network 114. In general a physiological property recorder 104 is any device adapted to record physiological properties (e.g. steps taken, heart rate, hours slept) of a user. Examples of a physiological property recorder 104 can include Fitbit, Nike⁺, Jawbone, a smart phone, smart glasses, and a smart watch. Client device 102 has a respective user 108 associated therewith. The server system 116 includes at least one computing device 118 and memory 120. Although only client device 102, physiological property recorder 104 and server system 116 are shown in the figure, example system 100 can include many more client devices, physiological property recorders, and servers which are not shown.

Network 114 can include a large computer network, examples of which include a local area network (LAN), wide area network (WAN), the Internet, a cellular network, or a combination thereof connecting a number of mobile client devices, fixed client devices, and server systems. The network(s) included in network 114 can provide for communications under various modes or protocols, examples of which include Transmission Control Protocol/Internet Protocol (TCP/IP), Global System for Mobile communication (GSM) voice calls, Short Electronic message Service (SMS), Enhanced Messaging Service (EMS), or Multimedia Messaging Service (MMS) messaging, Ethernet, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication can occur through a radio-frequency transceiver. In addition, short-range communication can occur, e.g., using a Bluetooth, WiFi, or other such transceiver system.

Client device 102 enables user 108 to engage a graphical user interface (“GUI”) that is associated with the application. The application can be stored on and executed by the client device 102 or the server system 116.

In example system 100, client device 102 is illustrated as a mobile computing device. It is noted, however, that client device 102 can include, e.g., a desktop computer, a laptop computer, a handheld computer, a television with one or more processors embedded therein and/or coupled thereto, a tablet computing device, a personal digital assistant (PDA), a cellular telephone, a network appliance, a camera, a smart phone, a smart watch, an enhanced general packet radio service (EGPRS) mobile phone, a media player, a navigation device, an electronic messaging device, a game console, or a combination of two or more of these data processing devices or other appropriate data processing devices. In some implementations, a client device can be included as part of a motor vehicle (e.g., an automobile).

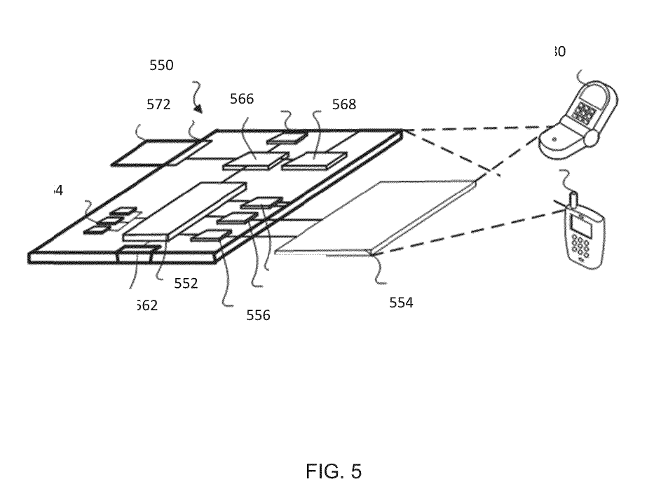

Client device 102 can execute an application 132 for helping a user achieve a goal. The application 132 can allow for execution of the methods described in this specification, and can be implemented as software, hardware or a combination of software and hardware that is executed on a processing apparatus, such as one or more computing devices (e.g. as described in relation to element 552 of FIG. 5).

The application 132 can be hosted by a corresponding goal tracking module 124 located on server system 116, which can be implemented as software, hardware or a combination of software and hardware that is executed on a processing apparatus, such as one or more computing devices.

### Goal Tracking Application

Individuals often set personal goals, but failure to achieve such goals is common. Thus, it can be desirable to employ a method that can help individuals achieve their personal goals. Further, it can be even more desirable if the method incorporates concepts found in popular, character-driven, interactive games.

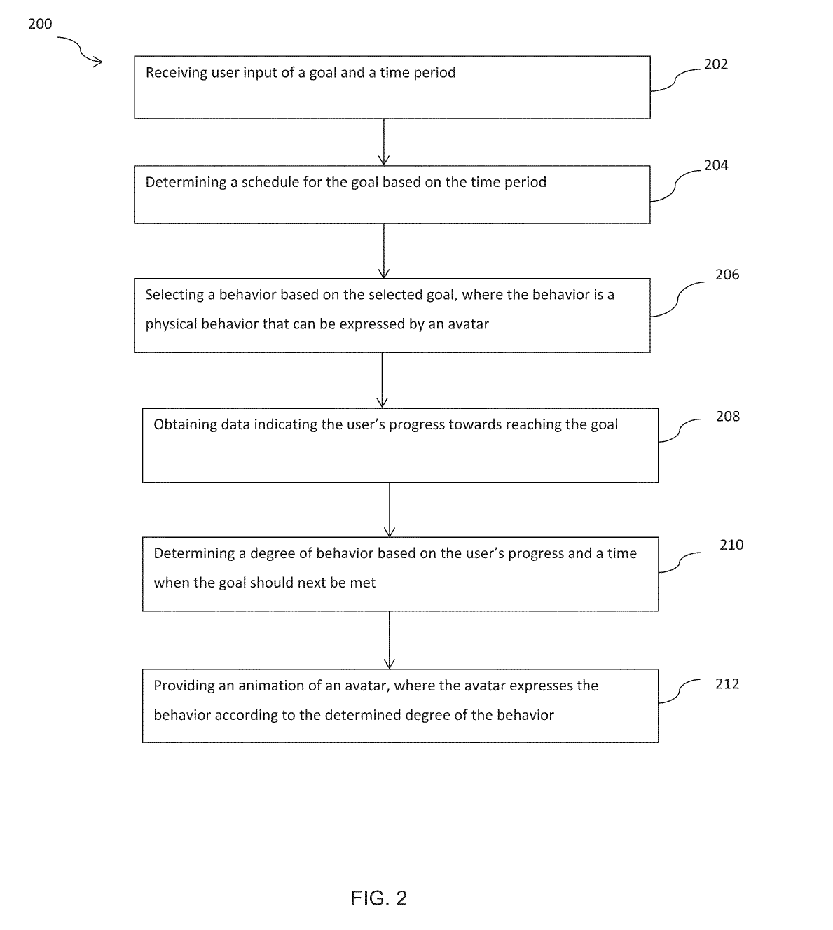

Implementation of the present disclosure relate to methods that can help users achieve personal goals. In general personal goals described in this disclosure can be anything a user desires to accomplish, for example, personal fitness, improved sleeping habits, learning a language, and saving money. Other personal goals are possible. In some instances, the methods can be performed by executing a goal tracking application 132 located on a client device 102 or one or more servers accessible by the client device. FIG. 2 is a flow chart showing an example method of achieving such personal goals. The method can include receiving 202 user input of a goal and a time period. In some instances, the user can select the goal and/or the time period from a pre-set list stored by a memory accessible by the application 132. In other instances, the user can input a custom goal and/or time period. Such input can be received through user interaction with a GUI presented by the application 132, for example. In implementations where the client device 102 has a touchscreen, users can make a selection using their finger or a stylus. In other instances, an input device such as, for example, a mouse or a keyboard can be used. Alternatively, in implementations having a voice user interface (“VUI”), input can be entered via the user's voice. In general, a goal is a behavior the user wishes to occur within the input time period, for example, an amount of physical exercise to complete (e.g. walking, running, jumping jacks, push-ups, pull-ups, weight training, boxing, kick boxing, bike riding, basketball, or swimming), an amount of food or beverage to consume, or an amount of rest or sleep to complete. A nonexclusive list of examples includes: walking 1 mile per day, drinking 5 glasses of water per day, and sleeping 56 hours per week. The method can include determining 204 a schedule for the selected goal based on the input time period. In some cases, the schedule can indicate one or more times when the goal should be met. Taking the example of a goal of walking 1 mile per day, the schedule can indicate that the user should walk 1 mile during each 24 hour period following the input of the goal, where the measured distance resets after each 24 hour period.

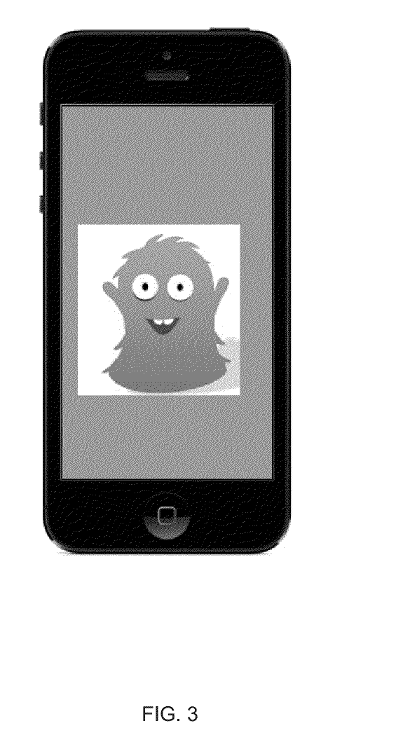

The method can include selecting 206 an action and/or behavior that can be expressed by a graphic or an avatar in an animation presented on the GUI. In general, an avatar can be any character, for example, a monster character or a pet character as shown in FIG. 3. In other instances, the avatar can resemble the user. In general, the behavior expressed by the avatar can be any activity, and in some instances can be based on the selected goal. In some cases, the behavior can be the desired behavior of the user. For example, if a user's goal is to walk 1 mile per day, the avatar's behavior can be to walk. In other cases, the behavior can be a physiological result of the user's desired behavior. For example, if a user's goal is to walk 1 mile per day, the avatar's behavior can be to lose weight. In other cases, the behavior can be an emotional reaction of the avatar, for example, if a user is on track to accomplish his or her goal the avatar can appear happy and if a user is not on track it can appear angry, frustrated or sad. Example emotions the avatar can express include boredom, happiness, fatigue, impatience, strength, or dismay. In other instances, a graphic can be displayed instead of an avatar. In such instances, the graphic can perform an action, which in some cases can be based on the selected goal. For example, in an instance where a user's goal is to read 5 books a month, the graphic may be a book, and the action may be turning the pages of the book as the user makes progress towards the goal.

The method can include obtaining 208 data indicating the user's progress towards reaching the goal. In some instances, such data can be programmatically obtained from any device configured to record physiological properties of a user, for example, a personal health monitor, a personal activity tracker (e.g. Fitbit, Jawbone, Nike⁺), a smart watch, smart glasses, or a smart phone. In general, any physiological property can be monitored, for example, distance walked, distance ran, type of activity conducted, activity duration, resting heart rate, exercise heart rate, resting blood pressure, glucose level, amount of liquid consumed, amount of sleep, gender, height, weight, and age. In some cases, goal tracking application 132 can be configured to record such physiological properties of its users. In other cases, other devices can communicate such information to the application 132, for example, through network 114. In other instances, data indicating a user's progress can be manually entered by the user. Such manual entry can occur through a user's engagement of the GUI presented by application 132.

The method can include determining 210 a degree of behavior for the user. In general, a degree of behavior is a measure of how much progress a user has made towards accomplishing his or her goal. In some instances, the degree of behavior can be determined based on the data indicating the user's progress towards reaching the goal and a time when the goal should next be met. Taking the example of a user having the goal of walking 1 mile per day, assume the application 132 is configured such that one 24 hour period ends and another begins at 12:00 AM, at which time the measurement of distance walked by the user resets as well. Further, assume application 132 has received data indicating that since the preceding 12:00 AM a user has walked 0.25 miles. In this instance, the users degree of behavior may be 25% because 25% of the goal has been accomplished during the current time period to accomplish the goal (i.e. until the next 12:00 AM). In some instances, a determination of a degree of behavior can based off of a time remaining before the time when the goal should next be met.

The method can include providing 212 an animation of the graphic and/or avatar in which the graphic and/or avatar expresses the selected action and/or behavior (discussed above in conjunction with method step 206) according to the determined degree of behavior. Thus, the avatar's behavior and/or the graphic's action can vary based on the amount of progress a user has made towards his or her goal. In some instances, the avatar's expressed behavior can affect the physical attributes of the avatar. In general, any physical attribute of the avatar can be affected. A nonexclusive list of examples includes the avatar's posture, its weight, muscle strength of any of its groups of muscles, muscle mass, facial expression, or clothing worn by the avatar. As an illustration of this concept, it may be helpful to revisit the examples discussed above; all related to a user's goal of walking 1 mile per day. Taking the example or the avatar's behavior being walking, the avatar may walk faster the further progress the user makes towards the goal, or in some cases the avatar may be displayed as having walked further (e.g. within an animation showing the avatar on a track or walking path). Conversely, if a user is not making progress towards the goal, the avatar may be displayed as standing still or moving slowly. Taking the example of the avatar's behavior being losing weight, the avatar may appear thinner the more progress a user makes towards the goal. Such changes in appearance can be extended over many time periods. For example, the avatar may only be displayed as having lost weight if a user walks 1 mile per day every day for a week or a month. In some cases, the avatar may only be displayed as having lost weight if the user has actually lost weight (e.g. as determined and communicated by a physiological property monitor). Conversely, if a user is not making progress towards the goal, the avatar may be displayed as gaining weight. Taking the example of the avatar expressing an emotional reaction, the more progress a user makes, the happier the avatar can appear. As one illustrative example, at 25% degree of behavior the avatar may smile, at 50% degree of behavior the avatar may have a bigger smile, at 75% degree of behavior the avatar may clap, and at 100% degree of behavior the avatar may do backflips of joy. Conversely, if a user is not making progress towards its goal, the avatar can become progressively more angry, frustrated, and/or upset. The above example is simply meant to illustrate examples of animations that can be expressed based on a determined degree of behavior. Many different behaviors and animations are possible. Similar concepts can be employed in instances in which a graphic is displayed instead of an avatar. Taking the example of a graphic of a book being presented, as a user makes progress towards his or her goal, more pages of the book can be turned.

In some implementations of the subject matter of this disclosure, the method can include notifying the user to achieve the goal before the time when the goal is next due. In general a notification can be provided at any time, for example, if the user's degree of behavior is not on track to achieve the goal. Taking the example of a user having the goal of walking 1 mile per day with one 24 hour period ending and another beginning at 12:00 AM, if at 6:00 PM (i.e. when 75% of the time period to accomplish the goal has passed) and the user has a degree of behavior that is less than 75% (e.g. the user has only walked 0.25 miles), a notification can be provided. In general a notification can use any technique that captures the user's attention, for example, a graphic, a sound, or a vibration. In some instances, the method can include learning times that are appropriate to notify the user, which in some instances can be based on the user's daily activities. In some cases, such times can be learned through user input of times he or she wishes to be reminded. In other cases, application 132 can learn such times by acquiring data from a user's personal calendar, which can be stored on client device 102 or a server accessible by the client device. In other cases, application 132 can track the times at which a notification results in a positive response from the user (e.g. user performs the reminded behavior and/or accomplishes the reminded goal) and/or times at which a notification results in a negative response (e.g. user does not perform the reminded behavior and/or fails to accomplish the reminded goal). In such cases, application 132 can provide future notifications at times that have resulted in positive responses, and avoid providing notifications at times that have resulted in negative responses. For example, if application 132 determines that a particular user often responds positively to reminders received in the morning, but not in the evening, the application 132 can provide future reminders in the morning rather than the evening.

As mentioned above, in certain implementations, the behavior of the avatar (e.g. determined by actions of the user) can affect the avatar's physical attributes. As one example, if the avatar's behavior is to lift weights (e.g in response to the user lifting weights), the muscle mass of the avatar can increase. As another example, if the avatar's behavior is to run (e.g. in response to the user running), the avatar's speed may increase. Some implementations of the disclosure can include a computer-implemented method that includes determining a model of the avatar based on its physical attributes, and communicating this model for use in an electronic game. Examples of electronic games can include, sports based games, fantasy based games, and massively multiplayer online role-playing games. Through execution of this method users can participate in an electronic game with a character modeled after their avatar. In some instances, the electronic game character can have the same physical appearance as the avatar. In other instances, the electronic game character can have a different physical appearance, but have physical attributes modeled off of the avatar. For example, in a football electronic game, the physical attributes of the quarterback can be modeled off of the physical attributes of the avatar. Taking this example a step further, if users wants to improve the arm strength of the quarterback they are using in an electronic game, they can perform arm exercises to improve the arm strength of their avatar provided by application 132, which can improve the arm strength of the quarterback (e.g. as a result of being modeled off of the avatar). Similar concepts can be applied to many other physical attributes and electronic game characters.

In some implementations, behaviors and physical attributes of the avatar of one user of application 132 can be communicated to another user of application 132. In some instances, such communication can be used to generate a training schedule for users of application 132, which in some cases can be based off the physical attributes of the avatar being communicated. For example, if user A is going to be competing against user B in a race, each user's avatar can be communicated to the other user. Within this example, the application of user A may determine that user B's avatar has certain physical attributes that make it faster than user A's avatar (e.g. strong thigh muscles). In response, user A's application may generate a training schedule for user A that includes behaviors to strengthen user A's thighs. Similar concepts can be applied to many other physical attributes and training schedules.

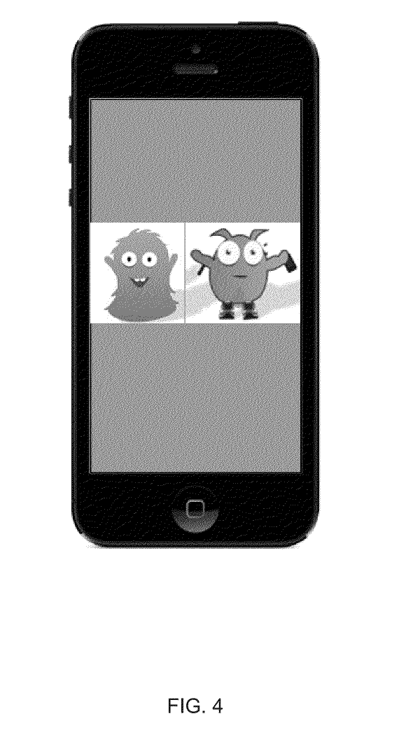

In some implementations, an animation of at least one other user's avatar can be displayed on the screen presented by application 132. In some instances, the presentation of the other user's avatar can be animated such that the other user's avatar expresses a behavior based on a degree of behavior of the other user. For example, if another user is running particularly fast, its avatar can be displayed on the screen of another user as running fast as well, or in some cases as panting hard (e.g. if the running is causing the other user to breathe heavily). In some cases, as shown for example in FIG. 4, avatars of different users can be presented on the same screen. In such cases, the two avatars may be presented as interacting with one another. For example if two users are performing an activity together (e.g. dancing), their avatars can be presented as dancing with one another. Similarly, if a group of users is all playing a game (e.g. basketball) together, their avatars can all be displayed as participating in the game. In other cases, avatars of different users can be presented on different screens.

In certain implementations the method can be used to perform long distance, real-time competitions. In this disclosure, long distance means any distance in which the competitors cannot physically see one another. In such implementations, although the users may not be able to physically see one another, they can determine some information about their competitor's performance by observing the behaviors and/or physical attributes of their competitor's avatar. For example, imagine user A lives in Boston and user B lives in California and the two want to participate in a 1 mile race. Technology exists that can allow both user A and user B to begin running at the same time, and to determine who finishes running the mile first. In fact, in some instances the goal tracking application 132 itself can facilitate these services. In addition, the goal tracking applications of the respective client devices of user A and user B can receive data from physiological property recorders associated with user A and user B. Such data can generally include any physiological characteristics of the user, for example, speed, heart rate, and lactic acid level. The client devices of user A and user B can communicate the received data to the client device of the other user (e.g. competitor), or in some cases it can be communicated to a central sever/the cloud where it can be accessed by the client device of the other user. Upon receipt of the physiological data of the other user, the goal tracking application 132 can present an avatar associated with the other user in a manner that reflects such data, which in some cases can occur in real time. For example, if the other user has a high heart rate, the avatar associated with that user can be presented as breathing heavily or sweating. As another example, if the other user has a high lactic acid level, the avatar associated with that user can be presented as showing a pained emotion. What an in person competition provides that is missing from a long distance competition, is the ability to see ones' competitor(s) and gain knowledge about their performance (or projected performance) based on their behavior and/or physical appearance. Implementations of the method described in this disclosure can allow users in long distance competitions to acquire such knowledge by observing the behaviors and/or physical attributes of their competitors' avatars.

### Operating Apparatus

FIG. 5 shows an example of a generic mobile computing device 550, which may be used with the techniques described in this disclosure. Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may in some cases be a cellular modem. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in FIG. 5. For example, it may be implemented as a cellular telephone 580. It may also be implemented as part of a smartphone 582, smart watch, personal digital assistant, or other similar mobile device.

### Operating Environment

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving user selection of a goal of a plurality of different goals and a time period, wherein the goal specifies a desired behavior of a user to occur within the time period;
determining a schedule for the selected goal based on the time period wherein the schedule indicates one or more times when the goal should be met;
selecting a behavior based on, at least, the selected goal wherein the behavior is a physical behavior that can be expressed by an avatar in an animation of the avatar;
obtaining data indicating the user's progress towards reaching the goal;
determining a degree of the behavior based on the user's progress and a time when the goal should be next be met; and
providing an animation of an avatar wherein the avatar expresses the behavior in the animation according to the determined degree of the behavior.

2. The method of claim 1 wherein a particular goal is an amount of food or beverage to consume in the time period, an amount of physical exercise to complete in the time period, or an amount of sleep or rest to complete in the time period.

3. The method of claim 1 wherein a particular physical exercise is walking, running, jumping jacks, push-ups, pull-ups, weight training, boxing, kick boxing, bike riding, basketball, or swimming.

4. The method of claim 1 wherein determining the degree of behavior comprises:
calculating a time remaining before the time when the goal should next be met; and
calculating the degree of the behavior based on the time remaining.

5. The method of claim 1 wherein a particular behavior is an expression of boredom, happiness, fatigue, impatience, strength, or dismay.

6. The method of claim 1 wherein obtaining the data comprises obtaining the data from user input or one or more devices that are configured to record physiological properties of a user.

7. The method of claim 6 wherein a particular device is a personal health monitor, a personal activity tracker, a smart watch, smart glasses, or a smart phone.

8. The method of claim 6 wherein a particular physiological property is distance walked, distance ran, type of activity, activity duration, resting heart rate, exercise heart rate, resting blood pressure, exercise blood pressure, glucose level, amount of liquid consumed, amount of sleep, gender, height, weight, and age.

9. The method of claim 1 wherein the expressed behavior affects one or more physical attributes of the avatar.

10. The method of claim 9 wherein a particular physical attribute is one of: posture, weight, muscle strength of a muscle group, muscle mass, facial expression, or clothing worn by the avatar.

11. The method of claim 9, further comprising:
determining a model of the avatar based on the physical attributes of the avatar; and
providing the model for use in an electronic game.

12. The method of claim 9, further comprising:
generating a training schedule for the user based on one or more physical attributes of another avatar of another user.

13. The method of claim 1 wherein providing the animation of the avatar comprises presenting the animation of the avatar on a client device associated with the user.

14. The method of claim 1, further comprising notifying the user to achieve the goal before the time when the goal should next be met.

15. The method of claim 14 wherein notifying the user to achieve the goal comprises:
learning times that are appropriate to notify the user based on the user's daily activities; and
notifying the user during one of the learned times.

16. The method of claim 1, further comprising:
providing a respective animation for one or more second avatars that each express a respective behavior in the animation according to a respective determined degree of the behavior for a different respective user.

17. The method of claim 16, further comprising:
updating the animations over time to reflect changes in respective determined behavior over time.

18. The method of claim 17 wherein each respective animation is of a physical activity.

19. The method of claim 18 wherein the physical activity is one of: walking, running, jumping jacks, push-ups, pull-ups, weight training, boxing, kick boxing, bike riding, basketball, and swimming.

20. A system comprising:
one or more computers programmed to perform operations comprising:
receiving user selection of a goal or of a plurality of different goals and a time period, wherein the goal specifies a desired behavior of a user to occur within the time period;
determining a schedule for the selected goal based on the time period wherein the schedule indicates one or more times when the goal should be met;
selecting a behavior based on, at least, the selected goal wherein the behavior is a physical behavior that can be expressed by an avatar in an animation of the avatar;
obtaining data indicating the user's progress towards reaching the goal;
determining a degree of the behavior based on the user's progress and a time when the goal should be next be met; and
providing an animation of an avatar wherein the avatar expresses the behavior in the animation according to the determined degree of the behavior.

21. The system of claim 20 wherein a particular goal is an amount of food or beverage to consume in the time period, an amount of physical exercise to complete in the time period, or an amount of sleep or rest to complete in the time period.

22. The system of claim 20 wherein a particular physical exercise is walking, running, jumping jacks, push-ups, pull-ups, weight training, boxing, kick boxing, bike riding, basketball, or swimming.

23. The system of claim 20 wherein determining the degree of behavior comprises:
calculating a time remaining before the time when the goal should next be met; and
calculating the degree of the behavior based on the time remaining

24. The system of claim 20 wherein a particular behavior is an expression of boredom, happiness, fatigue, impatience, strength, or dismay.

25. The system of claim 20 wherein obtaining the data comprises obtaining the data from user input or one or more devices that are configured to record physiological properties of a user.

26. The system of claim 20 wherein the expressed behavior affects one or more physical attributes of the avatar.

27. The system of claim 26 wherein the operations further comprise:
determining a model of the avatar based on the physical attributes of the avatar; and
providing the model for use in an electronic game.

28. The system of claim 26 wherein the operations further comprise:
generating a training schedule for the user based on one or more physical attributes of another avatar of another user.

29. The system of claim 20 wherein the operations further comprise notifying the user to achieve the goal before the time when the goal should next be met.

30. A storage device having instructions stored thereon that when executed by one or more computers perform operations comprising:
receiving user selection of a goal or of a plurality of different goals and a time period, wherein the goal specifies a desired behavior of a user to occur within the time period;
determining a schedule for the selected goal based on the time period wherein the schedule indicates one or more times when the goal should be met;
selecting a behavior based on, at least, the selected goal wherein the behavior is a physical behavior that can be expressed by an avatar in an animation of the avatar;
obtaining data indicating the user's progress towards reaching the goal;
determining a degree of the behavior based on the user's progress and a time when the goal should be next be met; and
providing an animation of an avatar wherein the avatar expresses the behavior in the animation according to the determined degree of the behavior.
